(19) United States
(12) Patent Application Publication
(10) Pub. No.: US 2014/0272665 A1
(43) Pub. Date: Sep. 18, 2014

(54) Ceramic Fuel Cell With Enhanced Flatness And Strength And Methods Of Making Same

(71) Applicants: Redox Power Systems, LLC, Fulton, MD (US); University of Maryland, College Park, College Park, MD (US)

(72) Inventors: Hee Sung YOON, College Park, MD (US); Eric D. WACHSMAN, Fulton, MD (US); Bryan M. BLACKBURN, Silver Spring, MD (US)

(73) Assignees: Redox Power Systems, LLC, Fulton, MD (US); University of Maryland, College Park, College Park, MD (US)

(21) Appl. No.: 14/206,930

(22) Filed: Mar. 12, 2014

Related U.S. Application Data
(60) Provisional application No. 61/780,109, filed on Mar. 13, 2013.

(51) Int. Cl. H01M 8/10; H01M 4/88

(52) U.S. Cl. CPC H01M 8/1004; H01M 8/1016; H01M 4/8875
USPC 429/482; 264/618

(57) ABSTRACT

Ceramic fuel cells having enhanced flatness and strength are disclosed. The fuel cell can include a half-cell having, in order, a patterned layer, an anode support layer and an electrolyte layer. Methods of making ceramic fuel cells are also provided.

### CROSS-REFERENCE TO RELATED APPLICATIONS

This application claims priority to the following U.S. Provisional patent application, which is hereby incorporated by reference in its entirety:
Ser. No. 61/780,109, titled “Anode Support Cell Structure”, filed Mar. 13, 2013.

### BACKGROUND

1. Field

The present disclosure relates to ceramic fuel cells and methods of making ceramic fuel cells. More specifically, the present disclosure relates to ceramic fuel cells having a patterned layer to enhance flatness and strength of the fuel cell.

2. Background

Ceramic fuel cells are being used in an increasing number of applications. Generally, ceramic fuel cells are multi-layer structures that are fabricated with cathode, electrolyte, and anode layers. Oftentimes, multiple fuel cells are stacked in series.

### BRIEF SUMMARY

Some embodiments disclosed herein include a ceramic fuel cell having, in order, a sintered patterned layer having a first coefficient of thermal expansion, a sintered anode support layer having a second coefficient of thermal expansion, a sintered first electrolyte layer having a third coefficient of thermal expansion, and a cathode layer. In certain embodiments, the second coefficient of thermal expansion is not between the first coefficient of thermal expansion and the third coefficient of thermal expansion.

In certain embodiments, a thickness of the sintered first electrolyte layer is less than a combined thickness of the sintered patterned layer and the sintered anode support layer. In certain embodiments, a thickness of the sintered patterned layer is at least as great as a thickness of the sintered first electrolyte layer. In certain embodiments, a thickness of the sintered patterned layer is 2 to 1500 microns, a thickness of the sintered anode support layer is 250 to 1500 microns, and a thickness of the sintered first electrolyte layer is 2 to 100 microns. In certain embodiments, a thickness of the sintered first electrolyte layer is between 5 to 30 microns.

In certain embodiments, the third coefficient of thermal expansion is within twenty five percent of the first coefficient of thermal expansion. In certain embodiments, the third coefficient of thermal expansion is within ten percent of the first coefficient of thermal expansion. In certain embodiments, the third coefficient of thermal expansion is within five percent of the first coefficient of thermal expansion. In certain embodiments, the third coefficient of thermal expansion is within one percent of the first coefficient of thermal expansion. In certain embodiments, the first and third coefficients of thermal expansion are substantially the same. In certain embodiments, the second coefficient of thermal expansion is at least 1 percent different from each of the first and third coefficients of thermal expansion.

In certain embodiments, the sintered patterned layer, sintered anode support layer, and sintered first electrolyte layer are fabricated by providing a first structure having, in order, a patterned layer having, prior to sintering, green bodies having a first composition; an anode support layer having, prior to sintering, green bodies having a second composition; and a first electrolyte layer having, prior to sintering, green bodies having a third composition. The first structure can be sintered at a first sintering temperature to obtain the sintered patterned layer, sintered anode support layer, and sintered first electrolyte layer. During sintering, the first composition can have a first shrinkage, the second composition can have a second shrinkage, and the third composition can have a third shrinkage. In certain embodiments, the second shrinkage is not between the first shrinkage and the third shrinkage.

In certain embodiments, the third shrinkage is within ten percent of the first shrinkage. In certain embodiments, the third shrinkage is within three percent of the first shrinkage. In certain embodiments, the third shrinkage is within one percent of the first shrinkage. In certain embodiments, the first and third shrinkages are equal. In certain embodiments, the second shrinkage is at least one percent different from each of the first shrinkage and the third shrinkage. In certain embodiments, the second shrinkage is between one and ten percent different from each of the first shrinkage and the third shrinkage.

In certain embodiments, the patterned layer, the anode support layer, and the first electrolyte layer are not constrained during sintering. In certain embodiments, the patterned layer, the anode support layer, and the first electrolyte layer are constrained during sintering.

In certain embodiments, after sintering the patterned layer, the anode support layer, and the first electrolyte layer, a second electrolyte layer can be provided over the first electrolyte layer. The second electrolyte layer can have, prior to sintering, green bodies having a fourth composition. In certain embodiments, the second electrolyte layer can be sintered at a second sintering temperature that is lower than the first sintering temperature.

In certain embodiments, after sintering the patterned layer, the anode support layer, and the first electrolyte layer, a cathode layer can be provided over the first electrolyte layer. The cathode layer can have, prior to sintering, green bodies having a fifth composition. In certain embodiments, the cathode layer can be sintered at a second sintering temperature that is lower than the first sintering temperature.

In certain embodiments, the first composition can include GDC, the second composition can include NiO-GDC, and the third composition can include GDC. In certain embodiments, the second composition can include NiO and Ce₁₋ₓGdₓO_{2-0.5x} powders, and the first and third compositions can include Ce₁₋ₓGdₓO_{2-0.5x} powder, where 0≦x≦0.2. In certain embodiments, the first composition and the third composition are at least partially made of the same material. In certain embodiments, the first composition and the third composition are the same.

In certain embodiments, the first electrolyte layer includes at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these electrolytes. In certain embodiments, the anode support layer includes a composite anode including NiO and one or more of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials. In certain embodiments, the patterned layer includes at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials.

In certain embodiments, the patterned layer includes one or more apertures. In certain embodiments, prior to sintering, each of the patterned layer, the anode support layer, and the first electrolyte layer is a green tape.

Some methods of making a ceramic fuel cell disclosed herein include providing a first structure having, in order, a patterned layer having, prior to sintering, green bodies having a first composition; an anode support layer having, prior to sintering, green bodies having a second composition; and a first electrolyte layer having, prior to sintering, green bodies having a third composition. In certain embodiments, the method includes sintering the first structure at a first sintering temperature to obtain a second structure having, in order, a sintered patterned layer, a sintered anode support layer, and a sintered first electrolyte layer. In certain embodiments, the sintered patterned layer has a first coefficient of thermal expansion, the sintered anode support layer has a second coefficient of thermal expansion, and the sintered first electrolyte layer has a third coefficient of thermal expansion. In certain embodiments, the second coefficient of thermal expansion is not between the first coefficient of thermal expansion and the third coefficient of thermal expansion.

In certain embodiments, a thickness of the sintered first electrolyte layer is less than a combined thickness of the sintered patterned layer and the sintered anode support layer. In certain embodiments, a thickness of the sintered patterned layer is at least as great as a thickness of the sintered first electrolyte layer. In certain embodiments, a thickness of the sintered patterned layer is 2 to 1500 microns, a thickness of the sintered anode support layer is 250 to 1500 microns, and a thickness of the sintered first electrolyte layer is 2 to 100 microns. In certain embodiments, a thickness of the sintered first electrolyte layer is between 5 to 30 microns.

In certain embodiments, the third coefficient of thermal expansion is within twenty five percent of the first coefficient of thermal expansion. In certain embodiments, the third coefficient of thermal expansion is within ten percent of the first coefficient of thermal expansion. In certain embodiments, the third coefficient of thermal expansion is within five percent of the first coefficient of thermal expansion. In certain embodiments, the third coefficient of thermal expansion is within one percent of the first coefficient of thermal expansion. In certain embodiments, the first and third coefficients of thermal expansion are substantially the same. In certain embodiments, the second coefficient of thermal expansion is at least 1 percent different from each of the first and third coefficients of thermal expansion.

In certain embodiments of the method, the sintered patterned layer, sintered anode support layer, and sintered first electrolyte layer are fabricated by sintering the first structure at a first sintering temperature to obtain the sintered patterned layer, sintered anode support layer, and sintered first electrolyte layer. During sintering, the first composition can have a first shrinkage, the second composition can have a second shrinkage, and the third composition can have a third shrinkage. In certain embodiments, the second shrinkage is not between the first shrinkage and the third shrinkage.

In certain embodiments, the third shrinkage is within ten percent of the first shrinkage. In certain embodiments, the third shrinkage is within three percent of the first shrinkage. In certain embodiments, the third shrinkage is within one percent of the first shrinkage. In certain embodiments, the first and third shrinkages are equal. In certain embodiments, the second shrinkage is at least one percent different from each of the first shrinkage and the third shrinkage. In certain embodiments, the second shrinkage is between one and ten percent different from each of the first shrinkage and the third shrinkage.

In certain embodiments of the method, the patterned layer, the anode support layer, and the first electrolyte layer are not constrained during sintering. In certain embodiments, the patterned layer, the anode support layer, and the first electrolyte layer are constrained during sintering.

In certain embodiments, the method further includes, after sintering the patterned layer, the anode support layer, and the first electrolyte layer, providing a second electrolyte layer over the first electrolyte layer, the second electrolyte layer having, prior to sintering, green bodies having a fourth composition. In certain embodiments, the second electrolyte layer can be sintered at a second sintering temperature that is lower than the first sintering temperature.

In certain embodiments, after sintering the patterned layer, the anode support layer, and the first electrolyte layer, a cathode layer can be provided over the first electrolyte layer. The cathode layer can have, prior to sintering, green bodies having a fifth composition. In certain embodiments, the cathode layer can be sintered at a second sintering temperature that is lower than the first sintering temperature.

In certain embodiments, the first composition can include GDC, the second composition can include NiO-GDC, and the third composition can include GDC. In certain embodiments, the second composition can include NiO and Ce₁₋ₓGdₓO_{2-0.5x} powders, and the first and third compositions can include Ce₁₋ₓGdₓO_{2-0.5x} powder, where 0≦x≦0.2. In certain embodiments, the first composition and the third composition are at least partially made of the same material. In certain embodiments, the first composition and the third composition are the same.

In certain embodiments, the first electrolyte layer includes at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these electrolytes. In certain embodiments, the anode support layer includes a composite anode including NiO and one or more of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials. In certain embodiments, the patterned layer includes at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials.

In certain embodiments, the patterned layer includes one or more apertures. In certain embodiments, prior to sintering, each of the patterned layer, the anode support layer, and the first electrolyte layer is a green tape. Apertures may be formed by any suitable method.

Some methods of making a ceramic fuel cell disclosed herein include providing a first structure having, in order, a patterned layer having, prior to sintering, green bodies having a first composition; an anode support layer having, prior to sintering, green bodies having a second composition; and a first electrolyte layer having, prior to sintering, green bodies having a third composition. In certain embodiments, the method includes sintering the first structure at a first sintering temperature to obtain a second structure having, in order, a sintered patterned layer, a sintered anode support layer, and a sintered first electrolyte layer. During sintering, the first composition can have a first shrinkage, the second composition can have a second shrinkage, and the third composition can have a third shrinkage. In certain embodiments, the second shrinkage is not between the first shrinkage and the third shrinkage.

In certain embodiments, a thickness of the sintered first electrolyte layer is less than a combined thickness of the sintered patterned layer and the sintered anode support layer. In certain embodiments, a thickness of the sintered patterned layer is at least as great as a thickness of the sintered first electrolyte layer. In certain embodiments, a thickness of the sintered patterned layer is 2 to 1500 microns, a thickness of the sintered anode support layer is 250 to 1500 microns, and a thickness of the sintered first electrolyte layer is 2 to 100 microns. In certain embodiments, a thickness of the sintered first electrolyte layer is between 5 to 30 microns.

In certain embodiments, the third shrinkage is within ten percent of the first shrinkage. In certain embodiments, the third shrinkage is within three percent of the first shrinkage. In certain embodiments, the third shrinkage is within one percent of the first shrinkage. In certain embodiments, the first and third shrinkages are equal. In certain embodiments, the second shrinkage is at least one percent different from each of the first shrinkage and the third shrinkage. In certain embodiments, the second shrinkage is between one and ten percent different from each of the first shrinkage and the third shrinkage.

In certain embodiments, the patterned layer, the anode support layer, and the first electrolyte layer are not constrained during sintering. In certain embodiments, the anode support layer, and the first electrolyte layer are constrained during sintering.

In certain embodiments, the method further includes, after sintering the patterned layer, the anode support layer, and the first electrolyte layer, providing a second electrolyte layer over the first electrolyte layer, the second electrolyte layer having, prior to sintering, green bodies having a fourth composition. In certain embodiments, the second electrolyte layer can be sintered at a second sintering temperature that is lower than the first sintering temperature.

In certain embodiments, the method further includes, after sintering the patterned layer, the anode support layer, and the first electrolyte layer, providing a cathode layer over the first electrolyte layer, the cathode layer having, prior to sintering, green bodies having a fifth composition. In certain embodiments, the cathode layer can be sintered at a second sintering temperature that is lower than the first sintering temperature.

In certain embodiments, the sintered patterned layer can have a first coefficient of thermal expansion, the sintered anode support layer can have a second coefficient of thermal expansion, and the sintered first electrolyte layer can have a third coefficient of thermal expansion. In certain embodiments, the second coefficient of thermal expansion is not between the first coefficient of thermal expansion and the third coefficient of thermal expansion. In certain embodiments, the third coefficient of thermal expansion is within twenty five percent of the first coefficient of thermal expansion. In certain embodiments, the third coefficient of thermal expansion is within ten percent of the first coefficient of thermal expansion. In certain embodiments, the third coefficient of thermal expansion is within five percent of the first coefficient of thermal expansion. In certain embodiments, the third coefficient of thermal expansion is within one percent of the first coefficient of thermal expansion. In certain embodiments, the first and third coefficients of thermal expansion are substantially the same. In certain embodiments, the second coefficient of thermal expansion is at least 1 percent different from each of the first and third coefficients of thermal expansion.

In certain embodiments, the first composition includes GDC, the second composition includes NiO-GDC, and the third composition includes GDC. In certain embodiments, the second composition includes NiO and Ce₁₋ₓGdₓO_{2-0.5x} powders, and the first and third compositions include Ce₁₋ₓGdₓO_{2-0.5x} powder, where 0≦x≦0.2. In certain embodiments, the first composition and the third composition are at least partially made of the same material. In certain embodiments, the first composition and the third composition are the same.

In certain embodiments, the first electrolyte layer includes at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these electrolytes. In certain embodiments, the anode support layer includes a composite anode including NiO and one or more of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials. In certain embodiments, the patterned layer includes at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials.

In certain embodiments, the patterned layer includes one or more apertures. In certain embodiments, prior to sintering, each of the patterned layer, the anode support layer, and the first electrolyte layer is a green tape.

Some embodiments disclosed herein include a ceramic fuel cell having a second structure including, in order, a sintered patterned layer, a sintered anode support layer, and a sintered first electrolyte layer, where the second structure is obtained by the process of providing a first structure including, in order, a patterned layer including, prior to sintering, green bodies having a first composition; an anode support layer including, prior to sintering, green bodies having a second composition; and a first electrolyte layer including, prior to sintering, green bodies having a third composition; and sintering the first structure at a first sintering temperature. During sintering, the first composition can have a first shrinkage, the second composition can have a second shrinkage, and the third composition can have a third shrinkage. In certain embodiments, the second shrinkage is not between the first shrinkage and the third shrinkage.

In certain embodiments, a thickness of the sintered first electrolyte layer is less than a combined thickness of the sintered patterned layer and the sintered anode support layer. In certain embodiments, a thickness of the sintered patterned layer is at least as great as a thickness of the sintered first electrolyte layer. In certain embodiments, a thickness of the sintered patterned layer is 2 to 1500 microns, a thickness of the sintered anode support layer is 250 to 1500 microns, and a thickness of the sintered first electrolyte layer is 2 to 100 microns. In certain embodiments, a thickness of the sintered first electrolyte layer is between 5 to 30 microns.

In certain embodiments, the third shrinkage is within ten percent of the first shrinkage. In certain embodiments, the third shrinkage is within three percent of the first shrinkage. In certain embodiments, the third shrinkage is within one percent of the first shrinkage. In certain embodiments, the first and third shrinkages are equal. In certain embodiments, the second shrinkage is at least one percent different from each of the first shrinkage and the third shrinkage. In certain embodiments, the second shrinkage is between one and ten percent different from each of the first shrinkage and the third shrinkage.

In certain embodiments, the patterned layer, the anode support layer, and the first electrolyte layer are not constrained during sintering. In certain embodiments, the patterned layer, the anode support layer, and the first electrolyte layer are constrained during sintering.

In certain embodiments, the process of obtaining the ceramic fuel cell further includes, after sintering the patterned layer, the anode support layer, and the first electrolyte layer, providing a second electrolyte layer over the first electrolyte layer, the second electrolyte layer including, prior to sintering, green bodies having a fourth composition. In certain embodiments, the second electrolyte layer can be sintered at a second sintering temperature that is lower than the first sintering temperature.

In certain embodiments, the process of obtaining the ceramic fuel cell further includes, after sintering the patterned layer, the anode support layer, and the first electrolyte layer, providing a cathode layer over the first electrolyte layer, the cathode layer including, prior to sintering, green bodies having a fifth composition. In certain embodiments, the cathode layer can be sintered at a second sintering temperature lower than the first sintering temperature.

In certain embodiments, the sintered patterned layer can have a first coefficient of thermal expansion, the sintered anode support layer can have a second coefficient of thermal expansion, and the sintered first electrolyte layer can have a third coefficient of thermal expansion. In certain embodiments, the second coefficient of thermal expansion is not between the first coefficient of thermal expansion and the third coefficient of thermal expansion. In certain embodiments, the third coefficient of thermal expansion is within twenty five percent of the first coefficient of thermal expansion. In certain embodiments, the third coefficient of thermal expansion is within ten percent of the first coefficient of thermal expansion. In certain embodiments, the third coefficient of thermal expansion is within five percent of the first coefficient of thermal expansion. In certain embodiments, the third coefficient of thermal expansion is within one percent of the first coefficient of thermal expansion. In certain embodiments, the first and third coefficients of thermal expansion are substantially the same. In certain embodiments, the second coefficient of thermal expansion is at least 1 percent different from each of the first and third coefficients of thermal expansion.

In certain embodiments, the first composition includes GDC, the second composition includes NiO-GDC, and the third composition includes GDC. In certain embodiments, the second composition includes NiO and Ce₁₋ₓGdₓO_{2-0.5x} powders, and the first and third compositions include Ce₁₋ₓGdₓO_{2-0.5x} powder, where 0≦x≦0.2. In certain embodiments, the first composition and the third composition are at least partially made of the same material. In certain embodiments, the first composition and the third composition are the same.

In certain embodiments, the first electrolyte layer includes at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these electrolytes. In certain embodiments, the anode support layer includes a composite anode including NiO and one or more of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials. In certain embodiments, the patterned layer includes at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials.

In certain embodiments, the patterned layer includes one or more apertures. In certain embodiments, prior to sintering, each of the patterned layer, the anode support layer, and the first electrolyte layer is a green tape.

### BRIEF DESCRIPTION OF THE DRAWINGS/FIGURES

The accompanying figures, which are incorporate herein, form part of the specification and illustrate embodiments of ceramic fuel cells and components thereof. Together with the description, the figures further to serve to explain the principals of and allow for the making and using of the ceramic fuel cells described herein. These figures are intended to be illustrative, not limiting. Although the disclosure is generally described in the context of these embodiments, it should be understood that it is not intended to limit the scope of the disclosure to these particular embodiments. In the drawings, like reference number indicate identical or functionally similar elements.

FIG. 1 illustrates a schematic diagram of ceramic fuel cell components, according to an embodiment disclosed herein.

FIG. 2 illustrates a schematic diagram of ceramic fuel cell components, according to an embodiment disclosed herein.

FIGS. 3(a)-3(c) are top and side view images of sintered ceramic fuel cells, with and without a patterned layer, according to embodiments disclosed herein.

FIGS. 4(a)-4(c) illustrate graphical flatness maps of the ceramic fuel cells in FIGS. 3(a)-3(c), respectively, according to embodiments disclosed herein.

FIG. 5 illustrates an exploded view of layers of a ceramic fuel cell, according to an embodiment disclosed herein.

FIG. 6 illustrates a top view and cross-sectional view of the ceramic fuel cell depicted in FIG. 5, according to an embodiment disclosed herein.

FIGS. 7(a)-7(d) illustrate forces acting on ceramic fuel cell components, according to embodiments disclosed herein.

### DETAILED DESCRIPTION

While the disclosure refers to illustrative embodiments for particular applications, it should be understood that the disclosure is not limited thereto. Modifications can be made to the embodiments described herein without departing from the spirit and scope of the present disclosure. Those skilled in the art with access to this disclosure will recognize additional modifications, applications, and embodiments within the scope of this disclosure and additional fields in which the disclosed examples could be applied. Therefore, the following detailed description is not meant to be limiting.

Further, it is understood that the devices and methods described herein can be implemented in many different embodiments of hardware. Any actual hardware described is not meant to be limiting. The operation and behavior of the device, systems, and methods presented are described with the understanding that modifications and variations of the embodiments are possible given the level of detail presented.

References to “one embodiment,” “an embodiment,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it may be used in combination with a feature, structure, or characteristic of other embodiments whether or not explicitly described.

In order to use fuel cells in smaller applications, it is desirable to make each fuel cell as thin and flat as possible. Having a flatter cell makes it less likely that a cell will break due to compressive forces placed on a cell during stack assembly and thermal stresses created during operation. Warping, bending, or curving of a cell can also cause localized stress concentration, which can cause certain areas of the cell to experience levels of stress that exceed the strength of the material, resulting in cracks during assembly or operation. Further, a flatter cell may also help with registration and alignment of the cells during stack assembly for quality assurance purposes. In other words, for cells with camber, a stack design may require additional features to ensure that a cell in one repeat unit is aligned similarly to a cell in a second repeat unit. If too many cells are misaligned, they may experience different stresses that cause their performance during operation to be different due to a different degree of sealing. In the case of SOFCs, a low performing cell can drag down the others, reducing the overall performance of a stack.

Certain physical properties of ceramic fuel cell components can cause warping of the fuel cell during the manufacturing process. This warping produces fuel cells that are not completely flat, thereby hampering the ability to stack multiple fuel cells and making the overall thickness of the fuel cell stack greater.

One cause of warping is differences in shrinkage of the ceramic fuel cell materials during sintering. Because fuel cells are generally made of multiple layers of material having different physical properties, during the sintering process each layer of material may not shrink the same amount. This can impart forces on the various layers, which can result in warping such as bowing, bending, or curving of the multiple layers.

Another cause of warping is differences in thermal expansion coefficients of the ceramic fuel cell materials as they cool after high temperature sintering. Similar to shrinkage, differences in thermal expansion of the fuel cell layers can impart forces on the various layers, which can result in warping such as bowing, bending, or curving of the multiple layers.

One way to reduce or avoid warping is to match the shrinkage and coefficient of thermal of expansion of the different layers. But such matching may involve other undesirable tradeoffs. In order to avoid such tradeoffs, it is desirable to have a way to accommodate differences in shrinkage and coefficient of thermal expansion, while still avoiding warping.

In order to produce thinner, flatter fuel cells, it is therefore desirable to reduce warping due to mismatch in the shrinkage during sintering and coefficient of thermal expansion of different layers. The embodiments disclosed herein enhance fuel cell flatness and increase overall strength of the fuel cells.

Solid oxide fuel cell (SOFC) fabrication often involves a first firing or sintering step, in which a “half-cell” is sintered. Generally, the half-cell includes anything present during this first firing, and does not include other parts of the solid oxide fuel cell. Other parts of the fuel cell are added subsequent to the first firing, and are often sintered at temperatures lower than the sintering temperature used in the first firing. In a conventional solid oxide fuel cell, the anode and at least a part of the electrolyte are included in the half-cell. In embodiments disclosed herein, a patterned layer, an anode layer, and a first electrolyte layer are included in the half-cell. Each of these layers can have sublayers. One example of a sublayer structure occurs in the anode layer, which can include an anode support sublayer and an anode functional sublayer. In certain embodiments, these anode sublayers can have the same material composition, but a different porosity obtained by controlling the particle size and binder/solvent parameters in the green body.

As referred to herein, a “green body” includes any ceramic compound prior to sintering. Green bodies can include, for example, ceramic powders. Green bodies also include ceramic compounds that have been screen printed, spray coated, etc., and examples of green bodies disclosed herein are not meant to be limiting. Further, green bodies can include additional substances, for example, binders to hold the green body together. Further, an example of a green body is a “green tape”, which can include any tape made from a ceramic compound or compounds prior to sintering. Examples of green tapes disclosed herein are not meant to be limiting.

Warping due to shrinkage mismatch and/or differences in coefficient of thermal expansion may be particularly acute during the first firing. And, such warping may also be particularly acute in an anode-supported structure.

Many embodiments disclosed herein are directed to using the patterned layer to counteract any force that the first electrolyte layer applies to the anode layer due to differential shrinkage from sintering during the first firing, differential thermal contraction as the half-cell cools from the sintering temperature, and differential thermal expansion and contraction due to any subsequent temperature changes during fabrication or operation of the fuel cell.

As indicated above, various “layers” described herein, such as the patterned layer, the anode support layer, and the first electrolyte layer, can have sublayers such that the composition is variable across the layer. Where a layer is described as having a “composition”, such as the patterned layer having a first composition, the term “composition” is intended to encompass variations across the layer due to sublayers. In one embodiment, one or more of each of the patterned layer, the anode support layer, and the first electrolyte layer have a uniform composition across the layer. In one embodiment, each of the patterned layer, the anode support layer and the first electrolyte layer has a uniform composition across the layer. These layers can be fabricated by sintering mixtures of different powders, tapes made from such powders, and other known green body structures. The term “uniform composition” means that the powder was well mixed prior to sintering, and is intended to encompass variations in the composition across the layer that normally occur when different types of powder are mixed and sintered. Different “sublayers” can result from stacking two tapes or other type of green bodies with a different blend of materials, particle sizes, or other parameter.

An example of a sublayer structure in the anode support layer is an “anode functional layer” (AFL) which can consist of particles that are different in particle size or composition (e.g., smaller NiO and GDC particles than are found in the anode support; different ratio of NiO to GDC than is found in the anode support; or if the anode support is made of something other than NiO-GDC, than the functional layer can still consist of NiO-GDC). An anode functional layer is typically the part of the anode closest to the electrolyte. The anode functional layer may have a higher surface area and finer microstructure than the rest of the anode in order to increase the electrochemical activity of the anode near the electrolyte, where a reaction may take place. The remainder of the anode may have a coarser structure to assist with gas flow through the anode.

Solid oxide fuel cells can also have layers in addition to the patterned layer, anode support layer, and first electrolyte layer that are sintered together in some embodiments. For example, a cathode is generally present. The cathode can be co-sintered with the patterned layer, anode support layer, and first electrolyte layer, or can be sintered separately. Other layers can be optionally provided. Such layers can be co-sintered with the patterned layer, anode support layer, and first electrolyte layer, or can be sintered separately. For example, a second electrolyte layer can be provided. The second electrolyte layer can be sintered separately from the first electrolyte layer. When a second electrolyte is present, a cathode can be co-fired or fired separately from the second electrolyte. Although many layers may or may not be sintered at the same time as other layers, as defined herein, a second electrolyte layer is sintered separately from a first electrolyte layer, and it is this separate sintering that defines the boundary between the first and second electrolyte layers.

In certain embodiments, a planar structure, such as the stacked patterned layer, anode support layer and first electrolyte layer can be externally constrained during sintering by placing the structure between, for example, two plates having a composition and structure such that the plates are rigid during sintering. Such constraint can reduce the degree to which the structure warps during sintering. But, such constraint adds process steps and can reduce the number of cells produced at any given time when the size of the processing kiln is fixed. Material from the plates can contaminate the structure being sintered. Special precautions that can be taken to reduce or avoid such contamination can add further expense and process steps. And the constraints can make outgassing of sintering byproducts more difficult. In some embodiments described herein, a sintering process with a low degree of warping can be achieved without using constraints during sintering, due to the properties and compositions of the structure being sintered.

In other embodiments, constraints can be used in conjunction with structures described herein. Because the structure being sintered has a low degree of warping, the constraints can play less of a role and the residual stresses in the sintered structure can be desirably less than residual stresses in a different structure that relied more heavily on the constraints to retain a planar shape during sintering.

Multi-layer electrolytes can be fabricated in a number of ways. For purposes of electrolyte thicknesses, shrinkage rates, coefficients of thermal expansion, and the like described in embodiments herein, the “first” electrolyte layer includes any part of the electrolyte that is sintered along with the anode support layer and patterned layer. The first electrolyte layer can include sublayers with different compositions, in which case the composite layer has a thickness, shrinkage rate, coefficient of thermal expansion, and other parameters. Any part of the electrolyte that is not sintered along with the anode support layer and patterned layer is considered a “second” or “additional” electrolyte layer, and the thickness, shrinkage rate, coefficient of thermal expansion, and other parameters of such a layer should not be considered when determining the parameters of the first electrolyte layer.

It is generally desirable to match shrinkage during sintering of layers that are sintered together, and coefficients of thermal expansion, in order to minimize warping. As used herein, shrinkage and coefficients of thermal expansion described as “the same” or “substantially the same” includes differences that are less than one percent. Such matching can involve undesirable trade-offs in other aspects of the device. In some embodiments, the structures disclosed herein allow for the use of an anode that has shrinkage during sintering and/or a coefficient of thermal expansion that is significantly different from that of the electrolyte and patterned layer, while still minimizing warping.

The “shrinkage” of a composition refers to the shrinkage during sintering of an isolated plate of the material. In the process described, the layers are sintered together and can be constrained by contact with other layers. In this situation, the entire structure can exhibit similar shrinkage, but the shrinkage differentials of the different compounds can result in residual stresses and warping of the sintered product. Shrinkage is measured as a percentage of a linear dimension on a plate:

Shrinkage=(Lᵢₙᵢₜᵢₐₗ−L_{final})/Lᵢₙᵢₜᵢₐₗ

Shrinkage itself is a percent. The “difference” in shrinkage percentage as used herein refers to a subtractive difference between the shrinkage percentages of various layers, as opposed to a percent of the percent. For example, the difference in shrinkage between a layer with 15% shrinkage and a layer with 20% shrinkage is 5% (20%−15%=5%), not 33% (15%*1.33=20%).

Differences between two coefficients of thermal expansion are described as a percentage of the value of the greater of two coefficients being compared. For example, the percentage difference between 12×10⁻⁶/K and 14×10⁻⁶/K is (14−12)/14=14.3%. Coefficient of thermal expansion (TEC) as used herein refers to linear thermal expansion of one dimension of a plate that is not the thickness:

TEC=((L_{final}−Lᵢₙᵢₜᵢₐₗ)/Lᵢₙᵢₜᵢₐₗ)/ΔK

FIG. 1 illustrates half-cell 100, prior to sintering, according to an embodiment. In certain embodiments, half-cell 100 can include patterned layer 102, anode support layer 104, and electrolyte layer 106. In certain embodiments, one or more of these layers can be green bodies, for example, green tapes, prior to sintering. The compositions of these green bodies can be the same or different.

In certain embodiments, patterned layer 102 can have one or more apertures 108. In certain embodiments, apertures 108 extend only partially through patterned layer 102. Preferably, apertures 108 extend entirely through patterned layer 102. This can facilitate gas diffusion through patterned layer 102. In certain embodiments, patterned layer 102 may be sufficiently thin and porous that apertures are not needed. The term “patterned layer” is intended to include such a structure for layer 102.

Many shapes, sizes, designs, and configurations are contemplated for apertures 108. For example, aperture 108 can be one large aperture or a plurality of apertures. In certain embodiments, apertures 108 can form a repetitive pattern, for example, a series of rectangles along patterned layer 102. In certain embodiments, the spacing and placement of apertures 108 can be irregular. Apertures 108 can be any shape, for example, but not limited to, squares, rectangle, circles, triangles, hexagons, other polygons, honeycombs, lattices, and the like. Each aperture 108 can be the same, or apertures 108 of different shapes and sizes can be included in a single patterned layer 102.

Each of patterned layer 102, anode support layer 104, and electrolyte layer 106 can have various compositions, for example, prior to sintering, each layer can be a green tape. In certain embodiments, patterned layer 102 can include at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials. In certain embodiments, anode support layer 104 can include a composite anode including NiO and one or more of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials. In certain embodiments, electrolyte layer 106 can include at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these electrolytes.

In certain embodiments, anode support layer 104 can be a composite of ceramic and other conductive metals. For example, anode support layer 104 can include a conductive metal or oxide of the metal (e.g., Nickel, Copper, Tungsten, Tin, Iron, Molybdenum, Cobalt, etc.) and one or more of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials. In certain embodiments, anode support layer 104 can be a composite of conductive ceramic and non-conductive ceramic materials. For example, anode support layer 104 can include a high conductivity ceramic (e.g., strontium titanate doped with lanthanum in the A-site or niobium in the b-site) and a non-conductive or low-conductivity ceramic (e.g., YSZ, SSZ, GDC, SDC, etc.). In certain embodiments, anode support layer 104 can be made entirely from a ceramic that is conductive. For example, anode support layer 104 can be a high conductivity ceramic (e.g., strontium titanate doped with lanthanum in the a-site or niobium in the b-site). In certain embodiments, anode support layer 104 can be made entirely from a ceramic where the ceramic is non-conductive or has low-conductivity, but metal is infiltrated into or otherwise introduced into the surface of the porous network in anode support layer 104.

The compositions of the half-cell layers can be the same, or they can be different. For example, in certain embodiments, patterned layer 102 and electrolyte layer 106 can be the same material, or at least partially the same material, for example GDC. In certain embodiments, anode support layer 104 can be NiO-GDC. In certain embodiments, anode support layer 104 can be made from NiO and Ce₁₋ₓGdₓO_{2-0.5x} powders, and patterned layer 102 and electrolyte layer 106 can be made from Ce₁₋ₓGdₓO_{2-0.5x} powder, where 0≦x≦0.2. In certain embodiments, nickel in these layers is in the form NiO prior to and just after sintering. During a period of operation known as conditioning, the anode is exposed to a reducing environment and the NiO becomes Ni metal.

Due to different compositions of the layers in half-cell 100, during sintering, each of patterned layer 102, anode support layer 104, and electrolyte layer 106 can experience a certain amount of shrinkage. The shrinkage of each layer can be described with respect to each other. For example, the shrinkage of electrolyte layer 106 can be within 10%, 3%, or 1% of the shrinkage of patterned layer 102. In certain embodiments, the shrinkage of patterned layer 102 and electrolyte layer 106 can be the same. In certain embodiments, the shrinkage of anode support layer 104 is not between the shrinkage of patterned layer 102 and electrolyte layer 106. In certain embodiments, the shrinkage of anode support layer 104 is at least 1% different from each of the shrinkages for patterned layer 102 and electrolyte layer 106. In certain embodiments, the shrinkage of anode support layer 104 is between 1% and 10% different from each of the shrinkages for patterned layer 102 and electrolyte layer 106.

FIG. 2 illustrates two embodiments of half-cells after sintering. Sintered half-cell 200 is not limited to these embodiments and can take many other forms described herein. Sintered half-cell 200 can include sintered patterned layer 202, sintered anode support layer 204, and sintered electrolyte layer 206. In certain embodiments, sintered patterned layer 202 can have one or more apertures 208, which can be in any of the forms described herein.

Each layer of sintered half-cell 200 can have various thicknesses. In certain embodiments, the thickness of the sintered electrolyte layer 206 is less than a combined thickness of the sintered patterned layer 202 and the sintered anode support layer 204. In certain embodiments, the thickness of the sintered patterned layer 202 is at least as great as the thickness of the sintered electrolyte layer 206. Generally, the thickness of sintered patterned layer 202 is 2 to 1500 microns, the thickness of sintered anode support layer 204 is 250 to 1500 microns, and the thickness of sintered electrolyte layer 206 is 2 to 100 microns. Preferably, the thickness of sintered electrolyte layer 206 is between 5 and 30 microns.

Due to different compositions of the layers in half-cell 200, the layers can have various coefficients of thermal expansion. The coefficients of thermal expansion can be described with respect to each other. For example, the coefficient of thermal expansion of sintered electrolyte layer 206 can be within 25%, 10%, 5%, or 1% of the coefficient of thermal expansion of sintered patterned layer 202. In certain embodiments, the coefficient of thermal expansion of sintered patterned layer 202 and sintered electrolyte layer 206 can be substantially the same. In certain embodiments, the coefficient of thermal expansion of sintered anode support layer 204 is not between the coefficient of thermal expansion of sintered patterned layer 202 and sintered electrolyte layer 206. In certain embodiments, the coefficient of thermal expansion of sintered anode support layer 204 is at least 1% different from each of the coefficients of thermal expansion for sintered patterned layer 202 and sintered electrolyte layer 206.

FIGS. 3(a)-(c) show top and side views of actual 5 cm×5 cm samples of sintered half-cells, according to embodiments disclosed herein. FIG. 3(a) shows a sintered half-cell without a patterned layer. FIG. 3(b) shows a sintered half-cell with a hollow patterned layer, similar to the one depicted on the right of FIG. 2. FIG. 3(c) shows a sintered half-cell with a grid patterned layer, similar to the one depicted on the left of FIG. 2. The side views show that the sintered half-cell without a patterned layer in FIG. 3(a) is more warped than the sintered half-cells in FIGS. 3(b) and 3(c), which each have a patterned layer.

FIGS. 4(a)-(c) illustrate computer-generated flatness maps for each of the sintered half-cells shown in FIGS. 3(a)-(c), respectively. Measurements were taken using a precision thickness gauge at 0.5 cm grid points in the x-y plane along the 5 cm×5 cm samples. The z-scale is in millimeters. As shown by the Figures, the sintered half-cells with patterned layers (FIGS. 4(b) and 4(c)) are flatter than the sintered half-cell without a patterned layer (FIG. 4(a)). In FIG. 4(a), some portions of the sintered half-cell are over 0.3 mm, whereas in FIGS. 4(b) and 4(c), no portions of the sintered half-cells are over 0.2 mm.

FIG. 5 illustrates multiple fuel cell repeat units 220, including an exploded view of a fuel cell repeat unit 220. Multiple fuel cell repeat units 220 can be provided in series to form a fuel cell stack 230. FIG. 6 illustrates a cross-sectional view through fuel cell stack 230. Each fuel cell repeat unit 220 can include sintered half-cell 200, which can include sintered patterned layer 202, sintered anode support layer 204, and sintered electrolyte layer 206, as described above. Sintered patterned layer 202 can include one or more apertures 208.

In addition to sintered half-cell 200, fuel cell repeat unit 220 can have a number of other layers. For example, fuel cell repeat unit 220 can include one or more additional electrolyte layer 212. In certain embodiments, additional electrolyte layer 212 can be provided in contact with sintered electrolyte layer 206. Additional electrolyte layer 212 can be the same or different composition as sintered electrolyte layer 206, for example, any of the electrolyte compositions described herein or various doped bismuth oxide materials. Additional electrolyte layer 212 can be sintered after sintering half-cell 200. In certain embodiments, additional electrolyte layer 212 can be sintered at a sintering temperature that is lower than the temperature at which half-cell 200 is sintered.

Fuel cell repeat unit 220 can also include cathode layer 210. In certain embodiments, cathode layer 210 can be provided in contact with sintered electrolyte layer 206. In certain embodiments, cathode layer 210 can be provided in contact with additional electrolyte layer 212, for example, as shown in FIG. 5. In certain embodiments, electrolyte layer 212 can be sintered at a sintering temperature that is lower than the temperature at which half-cell 200 is sintered. In certain embodiments, an additional cathode contact layer (not shown) can be added to the cathode. In certain embodiments, a mesh (not shown) that provides additional electrical connection can be additionally provided between the cathode contact layer and the interconnect layer of the next fuel cell repeat unit 220.

Fuel cell repeat unit 220 can also include anode contact layer 214. In certain embodiments, anode contact layer 214 can be provided in contact with sintered patterned layer 202 and anode support layer 204. In certain embodiments, anode contact layer 214 can be provided in contact only with anode support layer 204.

Fuel cell repeat unit 220 can also include interconnect layer 216. In certain embodiments, interconnect layer 216 can be provided in contact with other layers, such as a mesh (not shown) that provides additional electrical connection between interconnect layer 216 and anode contact layer 214.

FIGS. 7(a) and 7(b) illustrate layers of a half-cell 300. FIG. 7(a) illustrates differences in shrinkage of various layers that may occur during sintering. FIG. 7(b) illustrates the force that layer 306 applies on layer 304 as a result of the difference in shrinkage, and warping that occurs as a result. The longer arrows in layer 306 indicate that layer 306 shrinks more than layer 304 during sintering. During sintering, the difference in shrinkage of layers 306 and 304 can impart forces on the various layers, as indicated by the curved arrows, which can result in warping such as bowing, bending, or curving, as shown in half-cell 300 of FIG. 7(b). For example, if layer 306 shrinks more than layer 304, half-cell 300 will bend as shown in FIG. 7(b). The amount of bending depends upon a variety of factors, including the difference in shrinkage and the thicknesses of the layers.

FIGS. 7(c) and 7(d) illustrate layers of a half-cell. FIG. 7(c) illustrates differences in shrinkage of various layers that may occur during sintering. FIG. 7(d) illustrates the forces that layers 306 and layer 302 apply on layer 304 as a result of the difference in shrinkage, and warping that occurs as a result. In this embodiment, layer 306 and layer 302 each have more shrinkage than layer 304—put another way, the shrinkage of layer 304 is not between the shrinkage of layer 302 and the shrinkage of layer 306. For example, FIGS. 7(c) and 7(d) can represent an embodiment where an anode (e.g., layer 304) is located between a patterned layer (e.g., layer 302) and an electrolyte layer (e.g., layer 306), where the patterned layer and electrolyte layer have similar shrinkages. In such an embodiment, during sintering, layers 302 and 306 impart similar forces in opposite directions on layer 304, which can reduce warping relative to an otherwise similar structure where layer 302 is not present (see FIG. 7(b)), as shown in half-cell 310 of FIG. 7(d).

While FIG. 7 is used above to describe the effect differences in shrinkage have on different layers, the same concepts apply to differences in thermal expansion and contraction during heating and cooling.

While FIG. 7 illustrates an example where each of layers 302 and 306 contract more than layer 304, a similar principal applies where each of layers 302 and 306 contract less than layer 304, where each of layers 302 and 306 expand more than layer 304, and where each of layers 302 and 306 expand less than layer 304,

In the most general sense, FIG. 7 shows how layer 302 may be used to apply to layer 304 a “counteracting force” that counteracts, at least to some degree, the force applied to layer 304 by layer 306 due to differential shrinkage during sintering or differential thermal expansion or contraction during a temperature change. In the most general sense, for shrinkage, the criteria for such a counteracting force is that the shrinkage of layer 304 is not between the shrinkage of layer 302 and the shrinkage of layer 306—layers 302 and 306 either each shrink more than layer 304, or each shrink less than layer 304. For thermal expansion or contraction, the criteria for such a counteracting force is that the coefficient of thermal expansion of layer 304 is not between the coefficient of thermal expansion of layer 302 and the coefficient of thermal expansion of layer 306—layers 302 and 306 either each thermally expand (or contract) more than layer 304, or each thermally expand (or contract) less than layer 304.

Preferably, the force applied to layer 304 by layer 306 is equal in magnitude to the force applied to layer 304 by layer 302. This may be achieved by using similar materials and geometries for layers 302 and 306. An approach using the same materials for layer 302 and 306 is preferred in some situations, because it is then known that the shrinkage and coefficient of thermal expansion of layers 302 and 306 are the same. Forces of equal magnitude may also be achieved by any balance of materials and geometries for layers 302 and 306 that end up applying similar counteracting forces to layer 302. For example, if it is desired to have a cut-out pattern in a patterned support layer (layer 302) but not an electrolyte layer (layer 306), the thickness of layer 302 may be thicker than that of layer 306 to compensate. Or, it may be desired to have a particularly thin electrolyte layer (layer 306) because thin electrolytes lead to better SOFC performance. But layer 306 may be purely structural, making no contribution to the performance of the SOFC other than providing cut-outs and porosity for reactant gas to reach the anode and reaction product gas to exit the anode. In that case, it may be desirable that layer 306 is thicker than layer 302, and that cut-outs in the pattern of layer 306, and/or that layer 306 has a shrinkage or coefficient of thermal expansion different from that of layer 302.

Moreover, in order to reduce warping, the force applied to layer 304 by layer 306 need not be equal in magnitude to the force applied to layer 304 by layer 302, so long as the most general criteria described above for a “counteracting force” is met.

Warping may be reduced where either the shrinkage of layer 304 is not between the shrinkage of layer 302 and the shrinkage of layer 306, or the coefficient of thermal expansion of layer 304 is not between the coefficient of thermal expansion of layer 302 and the coefficient of thermal expansion of layer 306. It is preferable that both the shrinkage and thermal expansion criteria are met, but meeting only one of the criteria may still reduce warping relative to an otherwise similar structure without layer 302.

Various methods of making ceramic fuel cells and fuel cell components are described herein and several non-limiting examples are described in detail below. Generally, a first structure can be provided including, in order, a patterned layer, an anode support layer, and a first electrolyte layer. These layers can be made of any of the compositions described herein. These layers can also have any of the properties and relationship of properties described herein, for example, the thickness, coefficient of thermal expansion, shrinkage, and percentage differences between these properties in the layers.

In certain embodiments, the first structure can be sintered, forming a second structure having, in order, a sintered patterned layer, a sintered anode support layer, and a sintered first electrolyte layer. In certain embodiments, the patterned layer, anode support layer, and first electrolyte layer are not constrained during sintering. In certain embodiments, the patterned layer, anode support layer, and first electrolyte layer are constrained during sintering.

In certain embodiments, after sintering the patterned layer, the anode support layer, and the first electrolyte layer, a second electrolyte layer can be provided over the first electrolyte layer. In certain embodiments, the second electrolyte layer can be sintered at a second sintering temperature that is lower than the first sintering temperature.

In certain embodiments, after sintering the patterned layer, the anode support layer, and the first electrolyte layer, a cathode layer can be provided over the first electrolyte layer. In certain embodiments, the cathode layer can be provided over the second electrolyte layer after the second electrolyte layer has been provided over the first electrolyte layer. In certain embodiments, the cathode layer can be sintered at a second sintering temperature that is lower than the first sintering temperature. In certain embodiments, the cathode layer and the second electrolyte layer can be sintered at the same time.

### EXPERIMENTS

One purpose of the embodiments disclosed herein is to enhance fuel cell flatness, for example, by modifying the fuel cell structure to have a GDC electrolyte on a NiO-GDC anode support. In order to increase a cell size of GDC/NiO-GDC, a flatness of the cell has been characterized for a stack system. And, in certain embodiments, in order to enhance the cell flatness for an anode supported GDC/NiO-GDC, a patterned GDC layer was attached.

In certain embodiments, GDC and NiO-GDC green tapes were prepared by tape casting. In order to make a grid or hollow patterned GDC layer, GDC tape was cut out with a designated pattern for the fuel side. Using an NSK precision thickness gauge, the flatness was measured for 5 cm×5 cm cells with 0.5 cm between points along the x- and y-axis. The flatness mapping showed that a patterned GDC layer on the anode side produced a flatter cell than without the patterned layer (see FIGS. 4(a)-4(c)).

Some experiments and embodiments herein describe anode support layers (ASL) and anode functional layers (AFL) that include “NiO.” The nickel in these layers is in the form NiO prior to and just after sintering. During a period of operation known as conditioning, the anode is exposed to a reducing environment and the NiO becomes Ni metal.

Dimensions, materials, and methods disclosed for the experiments may be preferred in some contexts, but are not intended to limit the scope of the disclosed embodiments.

### Example 1

### Screen Printing Method

NiO-GDC ASL (Anode Support Layer) (400˜800 μm)

NiO-GDC ASLs were prepared by tape casting using NiO and Ce_{0.9}Gd_{0.1}O_{1.95} powders. A mixture of NiO (CAS 1313, Alfa Aesar) and GDC (HP grade, Fuel Cell Materials) powders in a ratio of 60:40 weight % was ball milled with Menhaden Fish Oil as a dispersant in a mixed Toluene/Ethyl alcohol solvent system for 24 hours to form a suspension. Butyl benzyl phthalate (BBP) plasticizer, and polyvinyl butyral (PVB) binder were added to the suspension and ball milled for another 24 hours to form a tape casting slurry. The slurry was transferred to a vacuum chamber for de-gassing. The slurry was tape-cast using Procast (DHI, Inc.). The resulting NiO-GDC tape was dried for 2 hours at 80° C.

NiO-GDC AFL (Anode Functional Layer) (5˜30 μm)

NiO-GDC AFLs were prepared by tape casting with smaller particles of NiO and Ce_{0.9}Gd_{0.1}O_{1.95} powder. A mixture of NiO (J. T. Baker) and GDC (HP grade, Fuel Cell Materials) powders in a ratio of 48:52 weight % was ball milled with Menhaden Fish Oil as a dispersant in a mixed Toluene/Ethyl alcohol solvent system for 24 hours to form a suspension. Butyl benzyl phthalate (BBP) plasticizer, and polyvinyl butyral (PVB) binder were added to the suspension and ball milled for another 24 hours to form a slurry. The slurry was transferred to a vacuum chamber for de-gassing. The slurry was tape-cast using Procast (DHI, Inc.).

GDC Electrolyte (5˜30 μm)

GDC electrolytes were prepared by tape casting Ce_{0.9}Gd_{0.1}O_{1.95} powder. GDC (HP grade, Fuel Cell Materials) powder was ball milled with Menhaden Fish Oil as a dispersant in a mixed Toluene/Ethyl alcohol solvent system for 24 hours to form a suspension. Butyl benzyl phthalate (BBP) plasticizer, and polyvinyl butyral (PVB) binder were added to the suspension and ball milled for another 24 hours to form a slurry. The slurry was transferred to a vacuum chamber for de-gassing. The slurry was tape-cast using Procast (DHI, Inc.).

These three tapes (NiO-GDC ASL, NiO-GDC AFL, and GDC electrolyte) were laminated to make a green body of GDC electrolyte/NiO-GDC AFL/NiO-GDC ASL.

Patterned GDC Layer (5˜30 μm)

GDC powder was mixed with texanol-based vehicle (441, ESL-ElectroScience Laboratory) using a Thinky Mixer in order to make a paste. GDC paste was applied on the NiO-GDC ASL surface with a specifically designed pattern using a screen printer. The GDC printed pattern on NiO-GDC (Green body of Patterned GDC/NiO-GDC ASL/NiO-GDC AFL/GDC electrolyte) was dried in an oven at 80° C. for 2 hours. The green body was burnt-out of the binder and plasticizer at 900° C. for 2 hours and sintered at 1450° C. for 4 hours.

LSCF-GDC Cathode (5˜30 μm)

Cathode inks were prepared by mixing La_{0.6}Sr_{0.4}Co_{0.2}Fe_{0.8}O_{3-δ} powder (Praxair) and GDC powder (HP grade, Fuel Cell Materials) in a ratio of 50:50 weight % with texanol-based vehicle (441, ESL) using a Thinky Mixer. After 30 minutes of mixing, the ink was blade-painted evenly onto the GDC electrolyte surface of a sintered body of a patterned GDC/NiO-GDC ASL/NiO-GDC AFL/GDC electrolyte. After drying for 2 hours at 80° C., the cathode was baked at 1100˜1200° C. for 2 hour.

### Example 2

### Slurry or Spray Coating Method

NiO-GDC ASL (Anode Support Layer) (400˜800 μm)

NiO-GDC ASLs were prepared by tape casting. A mixture of NiO (CAS 1313, Alfa Aesar) and GDC (HP grade, Fuel Cell Materials) powders in a ratio of 60:40 weight % was ball milled with Menhaden Fish Oil as a dispersant in a mixed Toluene/Ethyl alcohol solvent system for 24 hours to form a suspension. A mixture of butyl benzyl phthalate (BBP) plasticizer, and polyvinyl butyral (PVB) binder were added to the suspension and ball milled for another 24 hours to form slurry. The slurry was transferred to a vacuum chamber for de-gassing. The slurry was tape-cast using Procast (DHI, Inc.). The resulting NiO-GDC tape was dried for 2 hours at 80° C.

NiO-GDC AFL (Anode Functional Layer) (5˜30 μm)

NiO-GDC AFLs were prepared by tape casting a mixture of NiO and Ce_{0.9}Gd_{0.1}O_{1.95} powder. NiO (J. T. Baker) and GDC (HP grade, Fuel Cell Materials) powders in a ratio of 48:52 weight % were ball milled using Menhaden Fish Oil as a dispersant in a mixed Toluene/Ethyl alcohol solvent system for 24 hours to form a suspension. A mixture of butyl benzyl phthalate (BBP) plasticizer, and polyvinyl butyral (PVB) binder were added to the suspension and ball milled for another 24 hours to form a tape casting slurry. The slurry was transferred to a vacuum chamber for de-gassing. The slurry was tape-cast using Procast (DHI, Inc.).

GDC Electrolyte (5˜30 μm)

GDC electrolytes were prepared by tape casting Ce_{0.9}Gd_{0.1}O_{1.95} powder. GDC (HP grade, Fuel Cell Materials) powder was ball milled with Menhaden Fish Oil as a dispersant in a mixed Toluene/Ethyl alcohol solvent system for 24 hours to form a suspension. A mixture of butyl benzyl phthalate (BBP) plasticizer, and polyvinyl butyral (PVB) binder were added to the suspension and ball milled for another 24 hours to form a tape casting slurry. The slurry was transferred to a vacuum chamber for de-gassing. The slurry was tape-cast using Procast (DHI, Inc.).

These three tapes (NiO-GDC ASL, NiO-GDC AFL, and GDC electrolyte) were laminated together to make a green body of GDC electrolyte/NiO-GDC AFL/NiO-GDC ASL. A green body of GDC electrolyte/NiO-GDC AFL/NiO-GDC ASL was partially sintered at 900° C. for 2 hours.

Patterned GDC Layer (5˜30 μm)

GDC powder was mixed with texanol-based vehicle (441, ESL) and Ethyl alcohol using a Thinky Mixer in order to make a colloidal solution. The GDC colloidal solution was coated on the four edges with a specific designed pattern on the NiO-GDC ASL surface of a partially sintered body of NiO-GDC ASL/NiO-GDC AFL/GDC electrolyte using dip or spray coating methods. After drying the coated layer in an oven at 80° C. for 1 hour, the patterned GDC/NiO-GDC ASL/NiO-GDC AFL/GDC electrolyte was sintered at 1450° C. for 4 hours.

LSCF-GDC Cathode (5˜30 μm)

Cathode inks were prepared by mixing La_{0.6}Sr_{0.4}Co_{0.2}Fe_{0.8}O_{3-δ} powder (Praxair) and GDC powder (HP grade, Fuel Cell Materials) in a 50:50 weight % ratio with texanol-based vehicle (441, ESL) using a Thinky Mixer. After 30 minutes of mixing, the ink was blade-painted evenly onto the GDC electrolyte surface of a sintered body of a patterned GDC/NiO-GDC ASL/NiO-GDC AFL/GDC electrolyte. After drying for 2 hours at 80° C., the cathode was baked at 1100˜1200° C. for 2 hours.

### Example 3

### Lamination Method

NiO-GDC ASL (Anode Support Layer) (400˜800 μm)

NiO-GDC ASLs were prepared by tape casting. A mixture of NiO (CAS 1313, Alfa Aesar) and GDC (HP grade, Fuel Cell Materials) powders in a ratio of 60:40 weight % was ball milled using Menhaden Fish Oil as a dispersant in a mixed Toluene/Ethyl alcohol solvent system for 24 hours to form a suspension. Butyl benzyl phthalate (BBP) plasticizer, and polyvinyl butyral (PVB) binder were added to the suspension and ball milled for another 24 hours to form a slurry. The slurry was transferred to a vacuum chamber for de-gassing. The slurry was tape-cast using Procast (DHI, Inc.). The resulting NiO-GDC tape was dried for 2 hours at 80° C.

NiO-GDC AFL (Anode Functional Layer) (5˜30 μm)

NiO-GDC AFLs were prepared by tape casting. A mixture of NiO (J. T. Baker) and GDC (HP grade, Fuel Cell Materials) powders in a ratio of 48:52 weight % was ball milled with Menhaden Fish Oil as a dispersant in a mixed Toluene/Ethyl alcohol solvent system for 24 hours to form a suspension. Butyl benzyl phthalate (BBP) plasticizer, and polyvinyl butyral (PVB) binder were added to the suspension and ball milled for another 24 hours to form a slurry. The slurry was transferred to a vacuum chamber for de-gassing. The slurry was tape-cast using Procast (DHI, Inc.).

GDC Electrolyte Layer (5˜30 μm)

GDC tapes were prepared by tape casting Ce_{0.9}Gd_{0.1}O_{1.95} powder. GDC (HP grade, Fuel Cell Materials) powder was ball milled using Menhaden Fish Oil as a dispersant in a mixed Toluene/Ethyl alcohol solvent system for 24 hours to form a suspension. A mixture of butyl benzyl phthalate (BBP) plasticizer, and polyvinyl butyral (PVB) binder were added to the suspension and ball milled for another 24 hours to form a GDC slurry. The slurry was transferred to a vacuum chamber for de-gassing. The slurry was tape-cast using Procast (DHI, Inc.).

Patterned GDC Layer (5˜30 m)

A patterned GDC layer was prepared from the same GDC tapes for GDC electrolytes by cutting in order to make a specific pattern of GDC layer.

These four tapes were laminated together to make a green body of a patterned GDC Layer/NiO-GDC ASL/NiO-GDC AFL/GDC electolyte. Then, the green body was burnt-out of binder and plasticizer at 900° C. for 2 hours and sintered at 1450° C. for 4 hours.

LSCF-GDC Cathode (5˜30 μm)

Cathode inks were prepared by mixing La_{0.6}Sr_{0.4}Co_{0.2}Fe_{0.8}O_{3-δ} powder (Praxair) and GDC powder (HP grade, Fuel Cell Materials) in a ratio of 50:50 weight % with texanol-based vehicle (441, ESL) using a Thinky Mixer. After 30 minutes of mixing, the ink was blade-painted evenly onto the GDC electrolyte surface of a sintered body of a patterned GDC/NiO-GDC ASL/NiO-GDC AFL/GDC electrolyte. After drying for 2 hours at 80° C., the cathode was baked at 1100˜1200° C. for 2 hours.

The foregoing description has been presented for purposes of illustration and description. It is not intended to be exhaustive or to limit the precise embodiments disclosed. Other modifications and variations may be possible in light of the above teachings.

The embodiments and examples were chosen and described in order to best explain the principles of the embodiments and their practical application, and to thereby enable others skilled in the art to best utilize the various embodiments with modifications as are suited to the particular use contemplated. By applying knowledge within the skill of the art, others can readily modify and/or adapt for various applications such specific embodiments, without undue experimentation, without departing from the general concept. Therefore, such adaptations and modifications are intended to be within the meaning and range of equivalents of the disclosed embodiments, based on the teaching and guidance presented herein.

What is claimed is:

1. A ceramic fuel cell comprising, in order:
a sintered patterned layer having a first coefficient of thermal expansion;
a sintered anode support layer having a second coefficient of thermal expansion;
a sintered first electrolyte layer having a third coefficient of thermal expansion; and
a cathode layer,
wherein the second coefficient of thermal expansion is not between the first coefficient of thermal expansion and the third coefficient of thermal expansion.

2. The ceramic fuel cell of claim 1, wherein a thickness of the sintered first electrolyte layer is less than a combined thickness of the sintered patterned layer and the sintered anode support layer.

3. The ceramic fuel cell of claim 1, wherein a thickness of the sintered patterned layer is at least as great as a thickness of the sintered first electrolyte layer.

4. The ceramic fuel cell of claim 1, wherein a thickness of the sintered patterned layer is 2 to 1500 microns, a thickness of the sintered anode support layer is 250 to 1500 microns, and a thickness of the sintered first electrolyte layer is 2 to 100 microns.

5. The ceramic fuel cell of claim 1, wherein a thickness of the sintered first electrolyte layer is between 5 to 30 microns

6. The ceramic fuel cell of claim 1, wherein the third coefficient of thermal expansion is within twenty five percent of the first coefficient of thermal expansion.

7. The ceramic fuel cell of claim 1, wherein the third coefficient of thermal expansion is within ten percent of the first coefficient of thermal expansion.

8. The ceramic fuel cell of claim 1, wherein the third coefficient of thermal expansion is within five percent of the first coefficient of thermal expansion.

9. The ceramic fuel cell of claim 1, wherein the third coefficient of thermal expansion is within one percent of the first coefficient of thermal expansion.

10. The ceramic fuel cell of claim 1, wherein the first and third coefficients of thermal expansion are substantially the same.

11. The ceramic fuel cell of claim 1, wherein the second coefficient of thermal expansion is at least 1 percent different from each of the first and third coefficients of thermal expansion.

12. The ceramic fuel cell of claim 1, wherein the sintered patterned layer, sintered anode support layer, and sintered first electrolyte layer are fabricated by:
providing a first structure comprising, in order:
a patterned layer comprising, prior to sintering, green bodies having a first composition;
an anode support layer comprising, prior to sintering, green bodies having a second composition; and
a first electrolyte layer comprising, prior to sintering, green bodies having a third composition;
sintering the first structure at a first sintering temperature to obtain the sintered patterned layer, sintered anode support layer, and sintered first electrolyte layer;
wherein, during sintering, the first composition has a first shrinkage, the second composition has a second shrinkage, and the third composition has a third shrinkage; and
the second shrinkage is not between the first shrinkage and the third shrinkage.

13. The ceramic fuel cell of claim 12, wherein the third shrinkage is within ten percent of the first shrinkage.

14. The ceramic fuel cell of claim 12, wherein the third shrinkage is within three percent of the first shrinkage.

15. The ceramic fuel cell of claim 12, wherein the third shrinkage is within one percent of the first shrinkage.

16. The ceramic fuel cell of claim 12, wherein the first and third shrinkages are equal.

17. The ceramic fuel cell of claim 12, wherein the second shrinkage is at least one percent different from each of the first shrinkage and the third shrinkage.

18. The ceramic fuel cell of claim 12, wherein the second shrinkage is between one and ten percent different from each of the first shrinkage and the third shrinkage.

19. The ceramic fuel cell of claim 12, wherein the patterned layer, the anode support layer, and the first electrolyte layer are not constrained during sintering.

20. The ceramic fuel cell of claim 12, wherein the patterned layer, the anode support layer, and the first electrolyte layer are constrained during sintering

21. The ceramic fuel cell of claim 12, further comprising:
after sintering the patterned layer, the anode support layer, and the first electrolyte layer:
providing a second electrolyte layer over the first electrolyte layer, the second electrolyte layer comprising, prior to sintering, green bodies having a fourth composition; and
sintering the second electrolyte layer at a second sintering temperature lower than the first sintering temperature.

22. The ceramic fuel cell of claim 12, further comprising:
after sintering the patterned layer, the anode support layer, and the first electrolyte layer:
providing a cathode layer over the first electrolyte layer, the cathode layer comprising, prior to sintering, green bodies having a fifth composition; and
sintering the cathode layer at a second sintering temperature lower than the first sintering temperature.

23. The ceramic fuel cell of claim 12, wherein the first composition comprises GDC, the second composition comprises NiO-GDC, and the third composition comprises GDC.

24. The ceramic fuel cell of claim 12, wherein the second composition comprises NiO and Ce₁₋ₓGdₓO_{2-0.5x} powders, and the first and third compositions comprise Ce₁₋ₓGdₓO_{2-0.5x} powder, wherein 0≦x≦0.2.

25. The ceramic fuel cell of claim 12, wherein the first composition and the third composition are at least partially made of the same material.

26. The ceramic fuel cell of claim 12, wherein the first composition and the third composition are the same.

27. The ceramic fuel cell of claim 12, wherein the first electrolyte layer comprises at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these electrolytes.

28. The ceramic fuel cell of claim 12, wherein the anode support layer comprises a composite anode comprised of NiO and one or more of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials.

29. The ceramic fuel cell of claim 12, wherein the patterned layer comprises at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials.

30. The ceramic fuel cell of claim 1, wherein the patterned layer comprises one or more apertures.

31. The ceramic fuel cell of claim 1, wherein, prior to sintering, each of the patterned layer, the anode support layer, and the first electrolyte layer is a green tape.

32. A method of making a ceramic fuel cell comprising:
providing a first structure comprising, in order:
a patterned layer comprising, prior to sintering, green bodies having a first composition;
an anode support layer comprising, prior to sintering, green bodies having a second composition; and
a first electrolyte layer comprising, prior to sintering, green bodies having a third composition;
sintering the first structure at a first sintering temperature to obtain a second structure comprising, in order:
a sintered patterned layer;
a sintered anode support layer; and
a sintered first electrolyte layer;
wherein the sintered patterned layer has a first coefficient of thermal expansion, the sintered anode support layer has a second coefficient of thermal expansion, and the sintered first electrolyte layer has a third coefficient of thermal expansion;
the second coefficient of thermal expansion is not between the first coefficient of thermal expansion and the third coefficient of thermal expansion.

33. The method of claim 32, wherein a thickness of the sintered first electrolyte layer is less than a combined thickness of the sintered patterned layer and the sintered anode support layer.

34. The method of claim 32, wherein a thickness of the sintered patterned layer is at least as great as a thickness of the sintered first electrolyte layer.

35. The method of claim 32, wherein a thickness of the sintered patterned layer is 2 to 1500 microns, a thickness of the sintered anode support layer is 250 to 1500 microns, and a thickness of the sintered first electrolyte layer is 2 to 100 microns.

36. The method of claim 32, wherein a thickness of the sintered first electrolyte layer is between 5 to 30 microns

37. The method of claim 32, wherein the third coefficient of thermal expansion is within twenty five percent of the first coefficient of thermal expansion.

38. The method of claim 32, wherein the third coefficient of thermal expansion is within ten percent of the first coefficient of thermal expansion.

39. The method of claim 32, wherein the third coefficient of thermal expansion is within five percent of the first coefficient of thermal expansion.

40. The method of claim 32, wherein the third coefficient of thermal expansion is within one percent of the first coefficient of thermal expansion.

41. The method of claim 32, wherein the first and third coefficients of thermal expansion are substantially the same.

42. The method of claim 32, wherein the second coefficient of thermal expansion is at least 1 percent different from each of the first and third coefficients of thermal expansion.

43. The method of claim 32, wherein:
during sintering, the first composition has a first shrinkage, the second composition has a second shrinkage, and the third composition has a third shrinkage; and
the second shrinkage is not between the first shrinkage and the third shrinkage.

44. The method of claim 43, wherein the third shrinkage is within ten percent of the first shrinkage.

45. The method of claim 43, wherein the third shrinkage is within three percent of the first shrinkage.

46. The method of claim 43, wherein the third shrinkage is within one percent of the first shrinkage.

47. The method of claim 43, wherein the first and third shrinkages are equal.

48. The method of claim 43, wherein the second shrinkage is at least one percent different from each of the first shrinkage and the third shrinkage.

49. The method of claim 43, wherein the second shrinkage is between one and ten percent different from each of the first shrinkage and the third shrinkage.

50. The method of claim 43, wherein the patterned layer, the anode support layer, and the first electrolyte layer are not constrained during sintering.

51. The method of claim 43, wherein the patterned layer, the anode support layer, and the first electrolyte layer are constrained during sintering

52. The method of claim 43, further comprising:
after sintering the patterned layer, the anode support layer, and the first electrolyte layer:
providing a second electrolyte layer over the first electrolyte layer, the second electrolyte layer comprising, prior to sintering, green bodies having a fourth composition; and
sintering the second electrolyte layer at a second sintering temperature lower than the first sintering temperature.

53. The method of claim 43, further comprising:
after sintering the patterned layer, the anode support layer, and the first electrolyte layer:
providing a cathode layer over the first electrolyte layer, the cathode layer comprising, prior to sintering, green bodies having a fifth composition; and
sintering the cathode layer at a second sintering temperature lower than the first sintering temperature.

54. The method of claim 43, wherein the first composition comprises GDC, the second composition comprises NiO-GDC, and the third composition comprises GDC.

55. The method of claim 43, wherein the second composition comprises NiO and Ce₁₋ₓGdₓO_{2-0.5x} powders, and the first and third compositions comprise Ce₁₋ₓGdₓO_{2-0.5x} powder, wherein 0≦x≦0.2.

56. The method of claim 43, wherein the first composition and the third composition are at least partially made of the same material.

57. The method of claim 43, wherein the first composition and the third composition are the same.

58. The method of claim 43, wherein the first electrolyte layer comprises at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these electrolytes.

59. The method of claim 43, wherein the anode support layer comprises a composite anode comprised of NiO and one or more of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials.

60. The method of claim 43, wherein the patterned layer comprises at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials.

61. The method of claim 32, wherein the patterned layer comprises one or more apertures.

62. The method of claim 32, wherein, prior to sintering, each of the patterned layer, the anode support layer, and the first electrolyte layer is a green tape.

63. A method of making a ceramic fuel cell comprising:
providing a first structure comprising, in order:
a patterned layer comprising, prior to sintering, green bodies having a first composition;
an anode support layer comprising, prior to sintering, green bodies having a second composition; and
a first electrolyte layer comprising, prior to sintering, green bodies having a third composition;
sintering the first structure at a first sintering temperature to obtain a second structure comprising, in order:
a sintered patterned layer;
a sintered anode support layer; and
a sintered first electrolyte layer;
wherein, during sintering, the first composition has a first shrinkage, the second composition has a second shrinkage, and the third composition has a third shrinkage; and
the second shrinkage is not between the first shrinkage and the third shrinkage.

64. The method of claim 63, wherein a thickness of the sintered first electrolyte layer is less than a combined thickness of the sintered patterned layer and the sintered anode support layer.

65. The method of claim 63, wherein a thickness of the sintered patterned layer is at least as great as a thickness of the sintered first electrolyte layer.

66. The method of claim 63, wherein a thickness of the sintered patterned layer is 2 to 1500 microns, a thickness of the sintered anode support layer is 250 to 1500 microns, and a thickness of the sintered first electrolyte layer is 2 to 100 microns.

67. The method of claim 63, wherein a thickness of the sintered first electrolyte layer is between 5 to 30 microns.

68. The method of claim 63, wherein the third shrinkage is within ten percent of the first shrinkage.

69. The method claim 63, wherein the third shrinkage is within three percent of the first shrinkage.

70. The method of claim 63, wherein the third shrinkage is within one percent of the first shrinkage.

71. The method of claim 63, wherein the first and third shrinkages are equal.

72. The method of claim 63, wherein the second shrinkage is at least one percent different from each of the first shrinkage and the third shrinkage.

73. The method of claim 63, wherein the second shrinkage is between one and ten percent different from each of the first shrinkage and the third shrinkage.

74. The method of claim 63, wherein the patterned layer, the anode support layer, and the first electrolyte layer are not constrained during sintering.

75. The method of claim 63, wherein the patterned layer, the anode support layer, and the first electrolyte layer are constrained during sintering.

76. The method of claim 63, further comprising:
after sintering the patterned layer, the anode support layer, and the first electrolyte layer:
providing a second electrolyte layer over the first electrolyte layer, the second electrolyte layer comprising, prior to sintering, green bodies having a fourth composition; and
sintering the second electrolyte layer at a second sintering temperature lower than the first sintering temperature.

77. The method of claim 63, further comprising:
after sintering the patterned layer, the anode support layer, and the first electrolyte layer:
providing a cathode layer over the first electrolyte layer, the cathode layer comprising, prior to sintering, green bodies having a fifth composition; and
sintering the cathode layer at a second sintering temperature lower than the first sintering temperature.

78. The method of claim 63, wherein the sintered patterned layer has a first coefficient of thermal expansion, the sintered anode support layer has a second coefficient of thermal expansion, and the sintered first electrolyte layer has a third coefficient of thermal expansion, and wherein the second coefficient of thermal expansion is not between the first coefficient of thermal expansion and the third coefficient of thermal expansion.

79. The method of claim 78, wherein the third coefficient of thermal expansion is within twenty five percent of the first coefficient of thermal expansion.

80. The method of claim 78, wherein the third coefficient of thermal expansion is within ten percent of the first coefficient of thermal expansion.

81. The method of claim 78, wherein the third coefficient of thermal expansion is within five percent of the first coefficient of thermal expansion.

82. The method of claim 78, wherein the third coefficient of thermal expansion is within one percent of the first coefficient of thermal expansion.

83. The method of claim 78, wherein first and third coefficients of thermal expansion are substantially the same.

84. The method of claim 78, wherein the second coefficient of thermal expansion is at least 1 percent different from each of the first and third coefficients of thermal expansion.

85. The method of claim 63, wherein the first composition comprises GDC, the second composition comprises NiO-GDC, and the third composition comprises GDC.

86. The method of claim 63, wherein the second composition comprises NiO and Ce₁₋ₓGdₓO_{2-0.5x} powders, and the first and third compositions comprise Ce₁₋ₓGdₓO_{2-0.5x} powder, wherein 0≦x≦0.2.

87. The method of claim 63, wherein the first composition and the third composition are at least partially made of the same material.

88. The method of claim 63, wherein the first composition and the third composition are the same.

89. The method of claim 63, wherein the first electrolyte layer comprises at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these electrolytes.

90. The method of claim 63, wherein the anode support layer comprises a composite anode comprised of NiO and one or more of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials.

91. The method of claim 63, wherein the patterned layer comprises at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials.

92. The method of claim 63, wherein the patterned layer comprises one or more apertures.

93. The method of claim 63, wherein, prior to sintering, each of the patterned layer, the anode support layer, and the first electrolyte layer is a green tape.

94. A ceramic fuel cell comprising:
a second structure comprising, in order:
a sintered patterned layer;
a sintered anode support layer; and
a sintered first electrolyte layer;
wherein the second structure is obtained by the process of:
providing a first structure comprising, in order:
a patterned layer comprising, prior to sintering, green bodies having a first composition;
an anode support layer comprising, prior to sintering, green bodies having a second composition; and
a first electrolyte layer comprising, prior to sintering, green bodies having a third composition;
sintering the first structure at a first sintering temperature;
wherein, during sintering, the first composition has a first shrinkage, the second composition has a second shrinkage, and the third composition has a third shrinkage; and
the second shrinkage is not between the first shrinkage and the third shrinkage.

95. The ceramic fuel cell of claim 94, wherein a thickness of the sintered first electrolyte layer is less than a combined thickness of the sintered patterned layer and the sintered anode support layer.

96. The ceramic fuel cell of claim 94, wherein a thickness of the sintered patterned layer is at least as great as a thickness of the sintered first electrolyte layer.

97. The ceramic fuel cell of claim 94, wherein a thickness of the sintered patterned layer is 2 to 1500 microns, a thickness of the sintered anode support layer is 250 to 1500 microns, and a thickness of the sintered first electrolyte layer is 2 to 100 microns.

98. The ceramic fuel cell of claim 94, wherein a thickness of the sintered first electrolyte layer is between 5 to 30 microns.

99. The ceramic fuel cell of claim 94, wherein the third shrinkage is within ten percent of the first shrinkage.

100. The ceramic fuel cell of claim 94, wherein the third shrinkage is within three percent of the first shrinkage.

101. The ceramic fuel cell of claim 94, wherein the third shrinkage is within one percent of the first shrinkage.

102. The ceramic fuel cell of claim 94, wherein the first and third shrinkages are equal.

103. The ceramic fuel cell of claim 94, wherein the second shrinkage is at least one percent different from each of the first shrinkage and the third shrinkage.

104. The ceramic fuel cell of claim 94, wherein the second shrinkage is between one and ten percent different from each of the first shrinkage and the third shrinkage.

105. The ceramic fuel cell of claim 94, wherein the patterned layer, the anode support layer, and the first electrolyte layer are not constrained during sintering.

106. The ceramic fuel cell of claim 94, wherein the patterned layer, the anode support layer, and the first electrolyte layer are constrained during sintering.

107. The ceramic fuel cell of claim 94, further comprising:
after sintering the patterned layer, the anode support layer, and the first electrolyte layer:
providing a second electrolyte layer over the first electrolyte layer, the second electrolyte layer comprising, prior to sintering, green bodies having a fourth composition; and
sintering the second electrolyte layer at a second sintering temperature lower than the first sintering temperature.

108. The ceramic fuel cell of claim 94, further comprising:
after sintering the patterned layer, the anode support layer, and the first electrolyte layer:
providing a cathode layer over the first electrolyte layer, the cathode layer comprising, prior to sintering, green bodies having a fifth composition; and
sintering the cathode layer at a second sintering temperature lower than the first sintering temperature.

109. The ceramic fuel cell of claim 94, wherein the sintered patterned layer has a first coefficient of thermal expansion, the sintered anode support layer has a second coefficient of thermal expansion, and the sintered first electrolyte layer has a third coefficient of thermal expansion, and wherein the second coefficient of thermal expansion is not between the first coefficient of thermal expansion and the third coefficient of thermal expansion.

110. The ceramic fuel cell of claim 109, wherein the third coefficient of thermal expansion is within twenty five percent of the first coefficient of thermal expansion.

111. The ceramic fuel cell of claim 109, wherein the third coefficient of thermal expansion is within ten percent of the first coefficient of thermal expansion.

112. The ceramic fuel cell of claim 109, wherein the third coefficient of thermal expansion is within five percent of the first coefficient of thermal expansion.

113. The ceramic fuel cell of claim 109, wherein the third coefficient of thermal expansion is within one percent of the first coefficient of thermal expansion.

114. The ceramic fuel cell of claim 109, wherein the first and third coefficients of thermal expansion are substantially the same.

115. The ceramic fuel cell of claim 109, wherein the second coefficient of thermal expansion is at least 1 percent different from each of the first and third coefficients of thermal expansion.

116. The ceramic fuel cell of claim 94, wherein the first composition comprises GDC, the second composition comprises NiO-GDC, and the third composition comprises GDC.

117. The ceramic fuel cell of claim 94, wherein the second composition comprises NiO and Ce₁₋ₓGdₓO_{2-0.5x} powders, and the first and third compositions comprise Ce₁₋ₓGdₓO_{2-0.5x} powder, wherein 0≦x≦0.2.

118. The ceramic fuel cell of claim 94, wherein the first composition and the third composition are at least partially made of the same material.

119. The ceramic fuel cell of claim 94, wherein the first composition and the third composition are the same.

120. The ceramic fuel cell of claim 94, wherein the first electrolyte layer comprises at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these electrolytes.

121. The ceramic fuel cell of claim 94, wherein the anode support layer comprises a composite anode comprised of NiO and one or more of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials.

122. The ceramic fuel cell of claim 94, wherein the patterned layer comprises at least one of yttria stabilized zirconia (YSZ), scandia stabilized zirconia (SSZ), gadolinia doped ceria (GDC), samaria doped ceria (SDC), samarium-neodymium doped ceria (SNDC), strontium and magnesium doped lanthanum gallate (LSGM), and combinations of multiple dopants and stabilizers in these materials.

123. The ceramic fuel cell of claim 94, wherein the patterned layer comprises one or more apertures.

124. The ceramic fuel cell of claim 94, wherein, prior to sintering, each of the patterned layer, the anode support layer, and the first electrolyte layer is a green tape.
